(19) United States
(12) Patent Application Publication
(10) Pub. No.: US 2014/0230187 A1
(43) Pub. Date: Aug. 21, 2014

(54) DECORATIVE CHARM AND SCREW ATTACHMENT FOR USE WITH AN EYEGLASS FRAME

(71) Applicants: Kevin Philbin, Glenview, IL (US); Anthony Spatara, Chicago, IL (US)

(72) Inventors: Kevin Philbin, Glenview, IL (US); Anthony Spatara, Chicago, IL (US)

(21) Appl. No.: 14/014,049

(22) Filed: Aug. 29, 2013

Related U.S. Application Data
(60) Provisional application No. 61/766,875, filed on Feb. 20, 2013.

(51) Int. Cl. E05D 11/00; A44C 15/00

(52) U.S. Cl. CPC E05D 11/00; A44C 15/003
USPC 16/228

(57) ABSTRACT

A system incorporating a decorative attachment into a hinge established within an eyeglass frame. A first component has a downwardly extending portion inserting within the hinge and defined by aligning locations established between front and side portions of the eyeglass frame, the first component further having an upper projecting post. A second component includes any decorative configuration and exhibits a recessed underside which facilitates installation of the second component upon the upper projecting post of the first component such that the decorative component extends above, as opposed to aside, the hinge and temporal legs. Additional features include a linearly adjustable spacer at an intermediate location along the first component. The first component may further include a lower screw portion and an upper separable post portion.

### CROSS-REFERENCE TO RELATED APPLICATIONS

This application claims the benefit of U.S. Provisional Application 61/766,875 filed on Feb. 20, 2013, the contents of which are incorporated herein in its entirety.

### FIELD OF THE INVENTION

The present invention relates generally to a decorative charm attachable to a combination screw and upwardly projecting mounting post which substitutes for a standard eyeglass hinge screw between the front and each of the pivotally associated sides of the frame. The posts can be constructed in different sizes, heights and thread varieties in order to accommodate both different screw sockets and varying eyeglass frame thicknesses and the various decorative charms can further be constructed of ABS or other suitable moldable material and can be attached such as by screwing or downward pushing engagement upon the upper projecting post.

### BACKGROUND OF THE INVENTION

The prior art is documented with examples of decorative attachments such as which are associated with an eyeglass frame. One example of this is the ornamental attachment for use with an existing pair of eyeglasses having hinged junctions as depicted in U.S. Pat. No. 6,863,394 to Nelson et al.

The ornamental attachment in Nelson substitutes for an existing hinge screw and includes a hinge screw portion, a curved portion extending from the hinge screw portion, and an attachment portion extending from the curved portion. The attachment portion exhibits a decorative ornament extending laterally therefrom. The hinge screw portion is selectively inserted into the hinged junction of the eyeglasses after the (original) hinge screw is removed, and a small clip is affixed to a free end of the hinge screw portion in order to secure the ornamental attachment to the pair of eyeglasses.

Other references of note include the eyeglass frame ornamentation of Mendola U.S. Pat. No. 4,968,128 which includes removable attachments for use with an eyeglass frame. Nitta, U.S. Pat. No. 5,161,234 teaches a hanging ornament for eyeglasses which is associated with a joining member connected to a shaft screw in turn engaged with each hinge established between the temple leg and frame, the ornament portion freely attached on the hanging hole via a fastener means.

### SUMMARY OF THE INVENTION

The present invention discloses a collection of novel hinge attachment system combined with decorative charms which is not obvious in view of Nelson U.S. Pat. No. 6,863,394 or the other prior art. Specifically, the present invention discloses a system for incorporating a decorative attachment into a hinge established within an eyeglass frame, such including a first component having a first downwardly extending portion inserting within the hinge and defined by aligning locations established between front and side portions of the eyeglass frame, the first component further having an upper projecting post.

A second three dimensional component is provided and includes any decorative configuration. The second component further exhibits a recessed underside which facilitates installation of the second component upon the upper projecting post of the first component such that the decorative component extends above, as opposed to aside, the hinge and temporal legs.

Additional features include incorporating a linearly adjustable spacer at an intermediate location along the first component. The first component may further include a lower screw portion and an upper separable post portion.

Other features include a third end cap component which is attachable over the lower screw portion upon removal of the upper post. Each of the upper post portion and end cap may further exhibit an underside recess with internal threads for engaging additional external threads applied over an upper and larger diameter portion of the screw portion. The upper projecting post of the first component may further specifically exhibit, in non-limiting variants, either of a flattened or spherical shaped head.

The upper projecting post of the first component may further exhibit any of a flat, Phillips, hex or screw recess shaped pattern for receiving a screwdriver inserting bit portion. The downwardly extending portion of the first component can further exhibit a conically tapered end.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an illustration of a plurality of decorative attachments according to one non-limiting variant of the present invention;

FIGS. 2A-2D are a series of illustrations of an eyeglass frame with a pair of decorative attachments installed according to the present invention;

FIG. 3 is an illustration of a combination hinge screw and mounting post according to one non-limiting variant for receiving a decorative attachment;

FIG. 4 is an exploded view of a hinge screw and decorative charm mounting post according to a further embodiment of the invention;

FIGS. 5A-5B are top and side cutaway views of a collection of thread caps which can be mounted over the hinge screw in substitution of the mounting posts;

FIGS. 6A-6B, 7A-B, 8A-8B, 9A-9B, 10A-10B, 11A-11B, 12A-12B, 13A-13B, 14A-14B and 15A-15B each exhibit respective pairs of perspective and side views of combination hinge screws and mounting posts according to further related variants, each of which and exhibiting a flat head and intermediate located and annular enlarged collar;

FIGS. 16A-16B are perspective and side views of a further combination hinge screw and mounting post of flat heat variety and depicting a fine thread variant with minimal dimensioned and intermediately located post;

FIGS. 17A-17B are perspective and side views of a related variant of combination hinge screw and mounting post as compared to that shown in FIGS. 16A-16B and including a conically tapered hinge engaging portion; and

FIGS. 18A-18B are perspective and side views of a combination hinge screw and mounting post according to a yet further variant and which employs a spherical head to facilitate press-fit engagement of a decorative attachment; and

FIGS. 19A-19B are perspective and side top views of a combination hinge screw and mounting post combining the characteristics off the spherical head of FIGS. 18A-18B with the conically tapered hinge engaging portion of FIGS. 17A-17B.

### DETAILED DESCRIPTION OF THE PREFERRED EMBODIMENTS

As previously described, the present invention describes a decorative system incorporated into a pair of eyeglasses with hingedly connected sides and front, this including a charm attachable to a combination screw and upwardly projecting mounting post, and which substitutes for a standard eyeglass hinge screw between the front and each of the pivotally associated sides of the frame by being screwed into the hinged location in a substituting fashion. As will be additionally described, the posts can be constructed in different sizes, heights and thread varieties in order to accommodate both different screw sockets and varying eyeglass frame thicknesses and the various decorative charms can further be constructed of ABS or other suitable moldable material and can be attached such as by screwing or downward pushing engagement upon the upper projecting post.

Upon securely fastening in place the upwardly extending post, the user can quickly and efficiently affix or remove and substitute a variety of differently decorated charms. The posts are further constructed of a suitable material such as a stainless steel and which, depending upon the embodiment disclosed, can be threaded at both ends. It is also envisioned that a given unthreaded space can exist between the opposite threaded end posts (the lower for engaging the eyeglass hinge and the upper for receiving the decorative attachment, charm or pendant). As is further known, the posts can be constructed in different sizes, heights and thread varieties in order to accommodate both different screw sockets and varying eyeglass frame thicknesses.

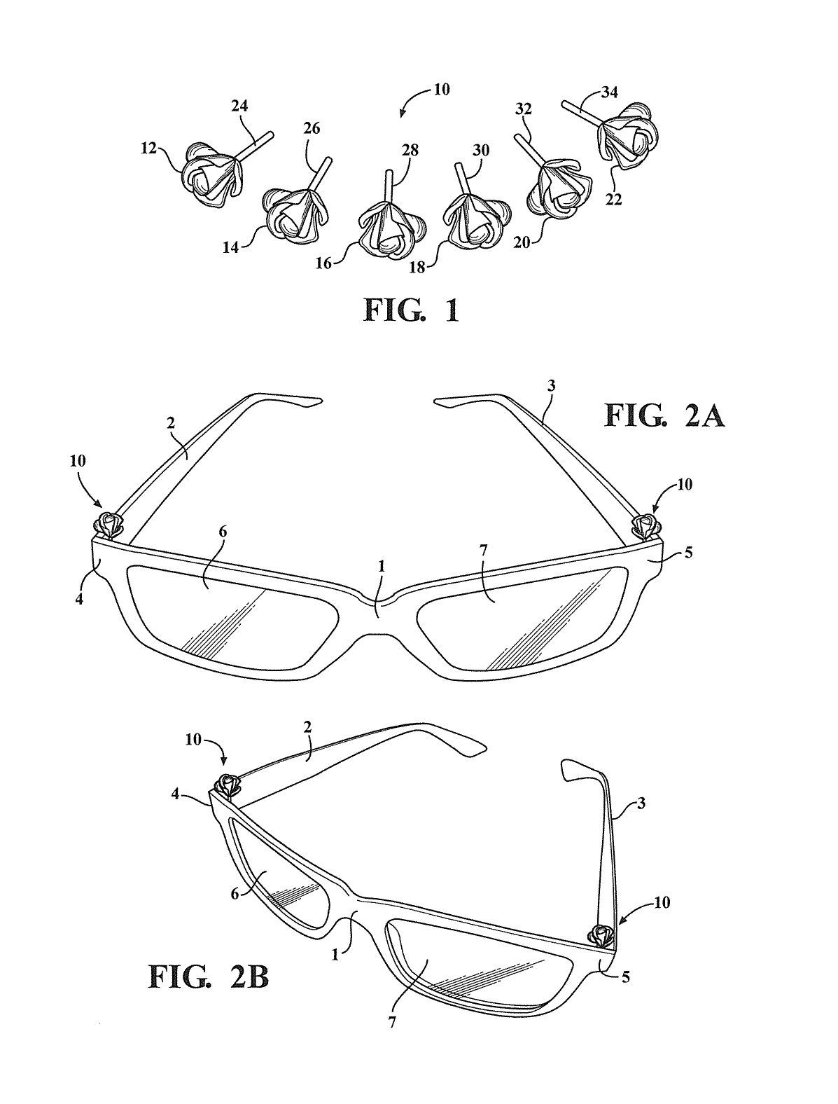

Referring to FIG. 1 an illustration is shown of a plurality of decorative attachments, and which is generally depicted at 10 in reference to the several attachments shown in order to represent the ability to provide such attachments in multiple colors and/or specific design orientations, this according to one non-limiting variant of the present invention. These are depicted as floral patterned designs, see decorative heads 12, 14, 16, 18, 20 and 22 with respective extending attachment stems 24, 26, 28, 30, 32 and 34.

The decorative heads 12-22 can be constructed of any suitable material, such as a plastic including acrylonitrile butadiene styrene (ABS) or other suitable material. The mounting stems 24-34 can be exteriorly threaded and are substituted for a typical eyeglass hinge screw.

Beyond what is shown, the decorative heads can be reconfigured to depict any of flowers, diamond or other gem-like shapes, sports objects or the like and which is targeted to appeal to various target demographics. It is also envisioned that, apart from making the decorative heads individually removable from the post and hinge mounting locations, it is envisioned that a plurality of one piece combination screw and decorative head attachments can be provided and which are substituted for one another within the eyeglass hinge. In such an application, the enlarged dimensions of the decorative head can assist in facilitating installation by being grasped by the user and rotated once the lower hinge portion is aligned and seated within the corresponding internal aligning threads consisting of the eyeglass hinge.

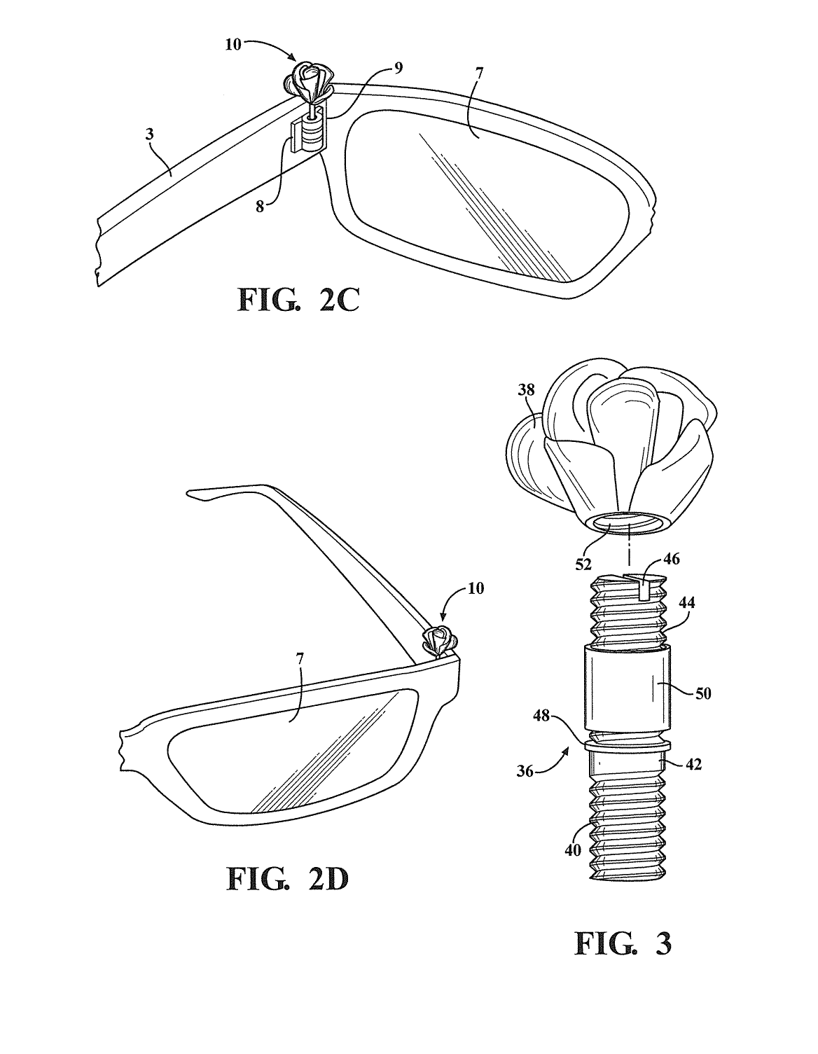

Proceeding to FIGS. 2A-2D, a series of illustrations are shown of a conventional eyeglass frame including a center lens supporting portion 1. A pair of hingedly interconnecting side portions (also termed temporal legs) 2 and 3 connect to sides 4 and 5 of the frame, between which are situated a pair of lenses 6 and 7.

Overlapping hinge defining portions (see as best shown at 8 and 9 in the partial rotated perspective of FIG. 2C) are provided between articulating end locations of each of the temporal legs 2 and 3 and the opposing sides 4 and 5 of the eyeglass frame. Upon removal of the standard hinge screw (not shown), a selected decorative attachment 10 with supporting stem is substituted in its place and in order to achieve the decorative effect shown in each of FIGS. 2A-2D.

As shown in FIGS. 2A-2D, the combination screw and decorative attachment 10 is adapted to extend above an upper adjoining edge established between a front and at least one side of the eyeglass frame. As further previously indicated, the depicted example of the decorative attachments illustrate but one of a number of different shapes, configurations and sizes which are possible.

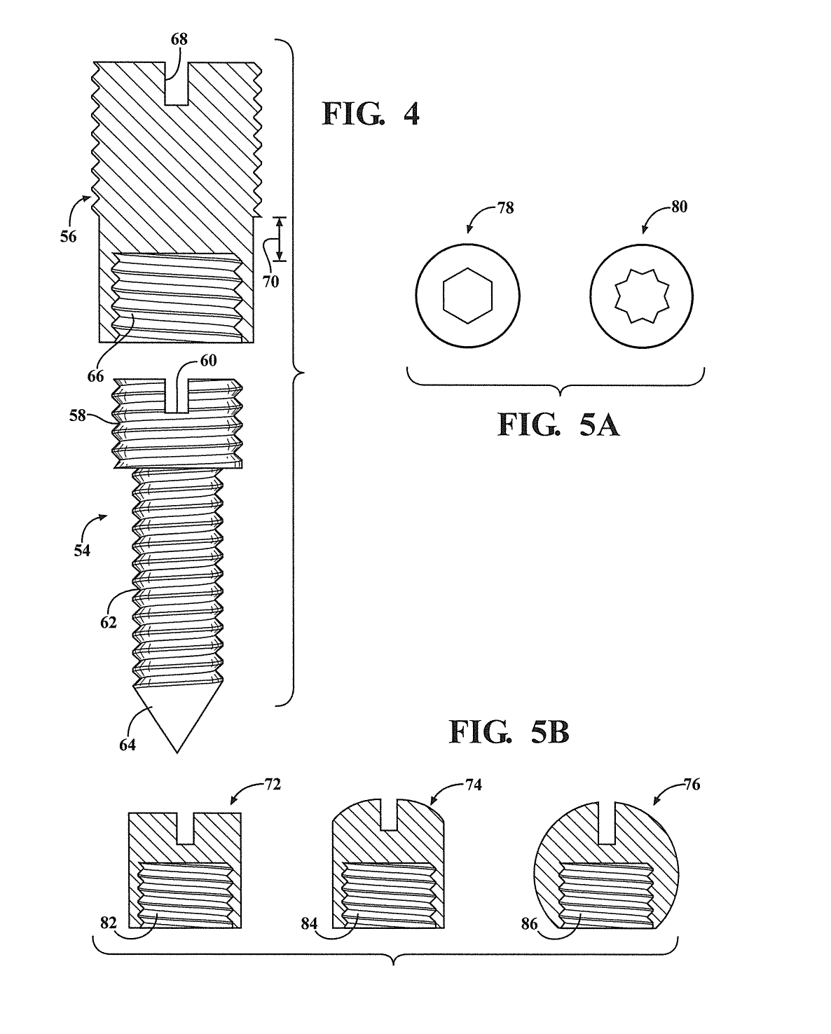

Proceeding to FIG. 3, an illustration is generally shown at 36 of a combination hinge screw and upwardly projecting mounting post according to a further non-limiting variant for receiving a decorative attachment 38 (as well as any other type of decorative or aesthetic pendant or the like). The screw 36 can be constructed of a grade steel or other suitable durable and reasonably hard surfaced material and which is intended to replace the standard hinge screw (again not shown). The combination screw 36 includes a lower exteriorly threaded shaft portion or post 40 (substituting for the standard exterior threads of the original hinge screw) terminating at an intermediate annular location 42.

An upper post is shown at 44 and (optionally) exhibits a like exteriorly threaded profile from a top keyed end (see screwdriver recess 46) to a bottom annular ledge 48 associated with the intermediate annular location 42. A cylindrical spacer 50 is provided installed over the upper post 44, the spacer 50 in one non-limiting configuration including an interior spiral threaded profile for facilitating linear adjustment along the length of the upper post 44.

The hinge screw with upper post can be integrated into a single component and both exhibit exterior threads as shown. The key or screwdrive recess 46 associated with the upper post 44 can be further modified or varied for engagement by any shaped tip or insertable bit of a screwdriver, such as without limitation including either flat, Phillips, Allen style or other bits, this facilitating pre-installation of the combination screw and post into the eyeglass hinge prior to top attachment of the decorative charm 38, such as further by press fitting the charm so that an annular configured and underside recess thereof (see inner perimeter wall 52) engages over the exterior of the post 44 in a force-fitting fashion.

Following installation of the modified hinge screw 36, the intermediately positioned and linearly adjustable collar or spacer 50 is re-positioned as necessary in order to provide different sizes or heights associated with either or both the eyeglass hinge or the sizing of the upper post 44 for receiving the decorative charm 38. The annular and underside facing recess profile 52 of the charm 38 can also be threaded as shown to facilitate attachment atop the mounting post 44 or, alternatively, either or both the recess underside 52 or the top annular portion of the post 44 can be smooth surfaced to facilitate a press (friction) fit engagement of the charm atop the modified hinge screw.

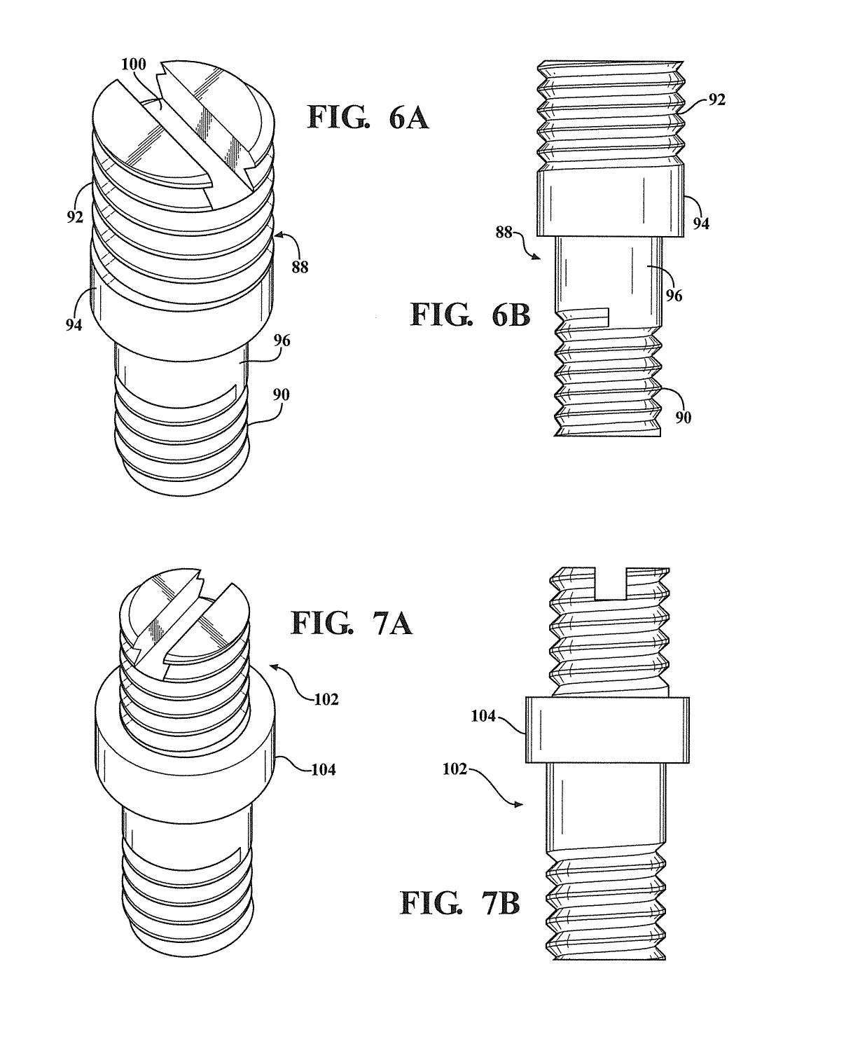

Prior to engaging in extended discussions of the related variants of the combination hinge screws and posts depicted throughout FIGS. 4-19, it is worth noting that these are designed to facilitate quick substation for the conventional hinge screw, with the upward extending dimensions of the upper posts being largely invisible in the absence of a decorative charm secured thereupon. The modified screw with decorative charm attachment post is further capable of being produced according to any diameter or height to accommodate all eyeglass manufacturer hinge specifications, with the intermediate spacer assisting in correct mounting and upward projection of the associated decorative shaped attachment (see again at 38 in FIG. 3). As previously discussed, the lower engagement post 40 and upper charm mounting post 44 are separated by an intermediate connecting portion of unthreaded area and which is not limited according to the depiction of FIG. 4 but which can include other design configurations either with or without the annular intermediate spacer 50 (such as which can further be either fixed or linearly adjustable as previously described).

Referring now to FIG. 4, an exploded view is shown of a hinge screw 54 and decorative charm mounting post 56 in linear cutaway and according to a further embodiment of the invention. The screw 54 includes an upper annularly enlarged and exteriorly threaded end 58, with a screwdriver receiving slot 60 defined within a top of the upper enlarged end 58. A lower shaft portion 62 is likewise exteriorly threaded and concludes in a tapered or pointed end 64 (it being also understood that this can be redesigned as a standard flat end screw).

The upper attachable mounting post 56 includes an underside exhibiting an interiorly threaded recess 66, such as which can be threadably attached in a rotationally installed fashion over an externally applied plurality of threads associated with the enlarged upper end 58 of the screw 54 and which is dimensioned to engage the internal threads of the threaded recess 66. A screwdriver tip receiving slot 68 is defined in a top surface of the post 56.

The design of the post 56 is further such that it incorporates the features of the intermediate spacer, this established by a height dimension between the inside upper end of the lower internally threaded underside 66 and the upper threads associated with the post 56 (see arrow 70). The height of this spacer area is variable to accommodate variables of eyeglass frames and to ensure proper positioning of the height of the post 56 for subsequent installation of the decorative charms (e.g. previously shown at 38 in FIG. 3) and like attachments.

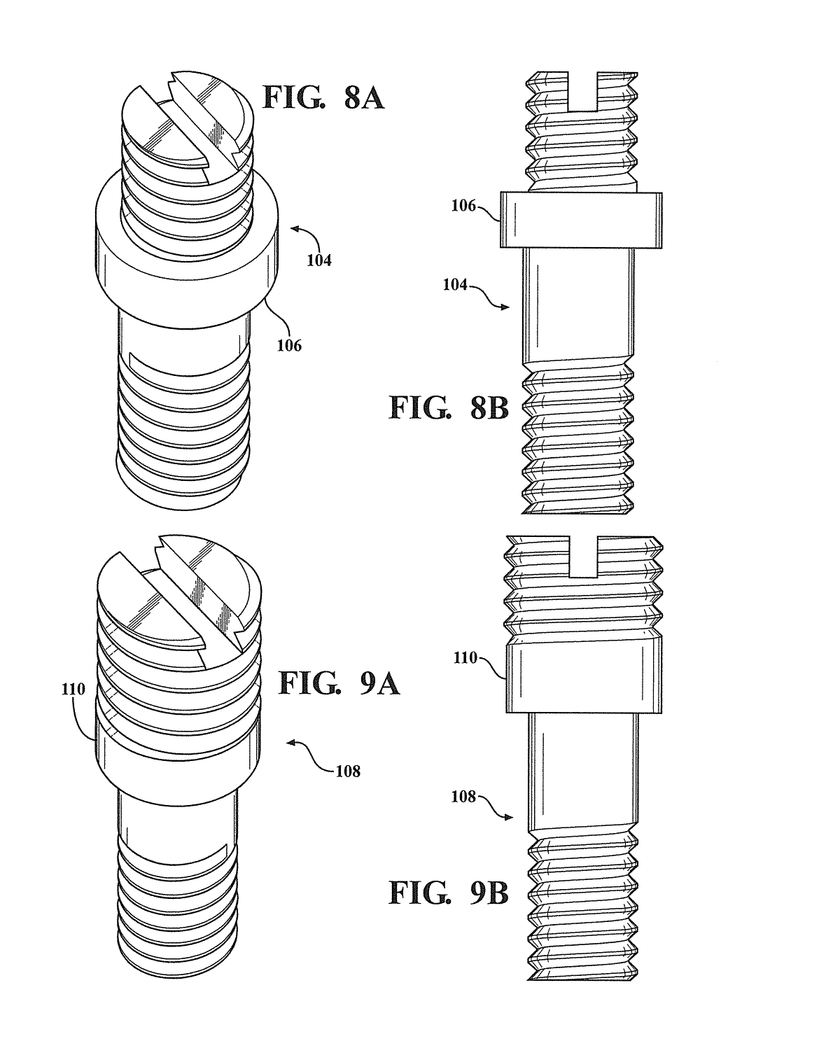

FIGS. 5A-5B are top and side cutaway views illustrating a variety of internally threaded caps which can mount over the hinge screw 54 of FIG. 4 in substitution of the post 56. As shown, the caps can exhibit any suitable three dimensional configuration which, similar to the post 56, includes each of a top engaging screwdriver slot and an underside screw recess for mounting a selected cap over the enlarged upper end 58 of the screw 54.

As further depicted in cutaway in FIG. 5B, a non-limiting collection of internally threaded caps includes a flat top version 72, an elliptical or bulbous projecting top surface version 74, and a spherical shaped version 76. The top views of FIG. 5A of selected threaded caps further depict non-limiting variations in the type of screwdriver bit receiving profiles, these in addition to standard flat or Phillips style receiver patterns and further depicting such as an internal hex pattern 78 (suitable for receiving an Allen style wrench or tool bit), as well as a related star pattern 80 or other suitable blade receiving profile for facilitating imparting sufficient torque to the mount the cap in place. In this fashion, and upon the user choosing to remove the decorative attachment or accessory (not shown in this figure) along with the separate post 56 to which the attachment is mounted, the cap 72, 74 or 76 is substituted by threadably engaging the underside interiors (see at 82, 84 or 86) to the external threads 58 of the hinge screw 54.

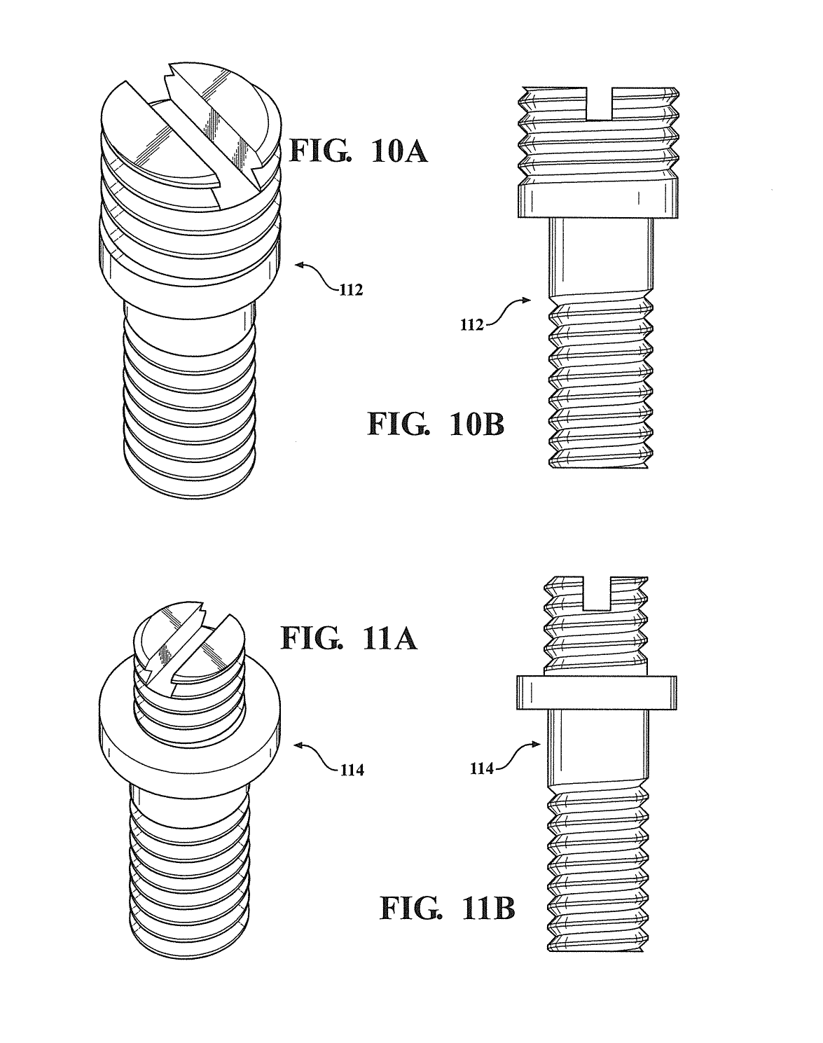

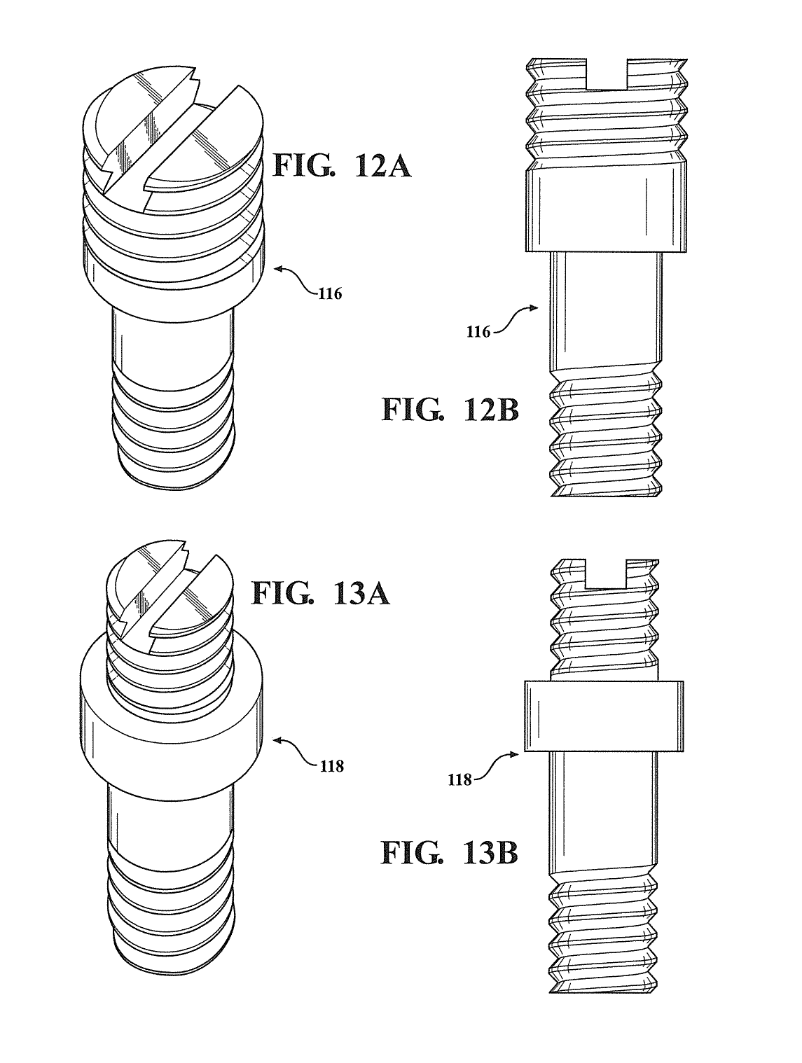

Referring successively to each of FIGS. 6A-6B, 7A-B, 8A-8B, 9A-9B, 10A-10B, 11A-11B, 12A-12B, 13A-13B, 14A-14B, 15A-15B, 16A-16B and 17A-17B, respective pairs of perspective and side views are shown of combination hinge screws and mounting posts according to further related variants compared to that previously depicted at 36 in FIG. 3, each of which exhibiting a flat head and intermediate located and annular enlarged collar according to a given dimension and/or profile. FIGS. 6A-B depict an example of an essential eyewear screw, generally at 88, and which includes a lower 90 and upper 92 threaded mounting shafts, stems or posts. An intermediate spacer location established between the lower 90 and upper 92 shafts is depicted by an upper and annular enlarged portion 94, corresponding to a width dimension of threaded upper mounting post 92, and a reduced width diameter location 96 corresponding to the lower hinge engagement post 90.

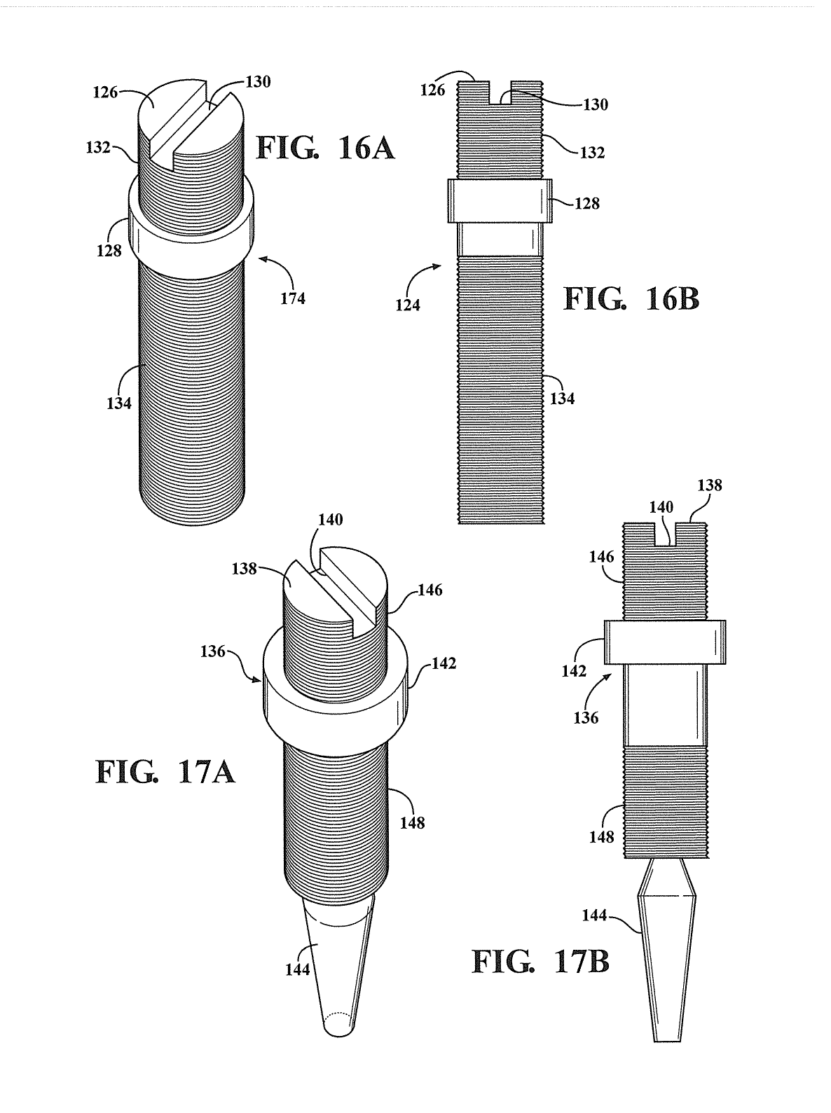

As with each succeeding variant up to that depicted in FIGS. 17A-17B, the upper post 92 terminates in a flat head or top (see surface 98) within which is defined a tool bit recess profile 100 (again depicting a profile suitable for engagement by a flat head screwdriver but not limiting to any specific bit engaging profile). As with the previously disclosed combination hinge screw of FIG. 3, the dimensions of the screw 88, as with each subsequently described variant, are modifiable in order to accommodate any specification of eyeglass hinge, temple leg or frame, as well as any suitable and top attachable decorative charm or pendant not limited to that shown in FIG. 3 at 38.

FIGS. 7A-7B generally depict a further example, at 102, of another variation of an essential eyewear screw and which is similar in most respects to that previously shown at 88, with the exception that the intermediate annular spacer is reconfigured/widened as compared to that depicted at 94. Unless otherwise indicated, and for purposes of clarity of illustration and description, specific features associated with any given combination hinge screw hereinafter described will only be specifically referenced if differing from that previously described.

FIGS. 8A-8B generally illustrate at 104 an Occhiolini® eyewear screw with an intermediate spacer 106 similar to that depicted in FIGS. 7A-7B for separating the (downward) hinge post/screw and upper decorative attachment posts. FIGS. 9A-9B illustrate another variation of an Occhiolini® screw 108 with an intermediate spacer profile (including at 110) which is similar to that depicted in FIGS. 6A-6B.

Additional modified hinge screws include those particularly configured for the Ray Ban® Black Case, such as generally at 112 in FIGS. 10A-10B, at 114 in FIGS. 11A-11B, at 116 in FIGS. 12A-12B, and at 118 in FIGS. 13A-13B. Additional examples of modified hinge screws for application with Vogue® eyewear include such as those generally depicted at 120 in FIGS. 14A-14B and at 122 in FIGS. 15A-15B.

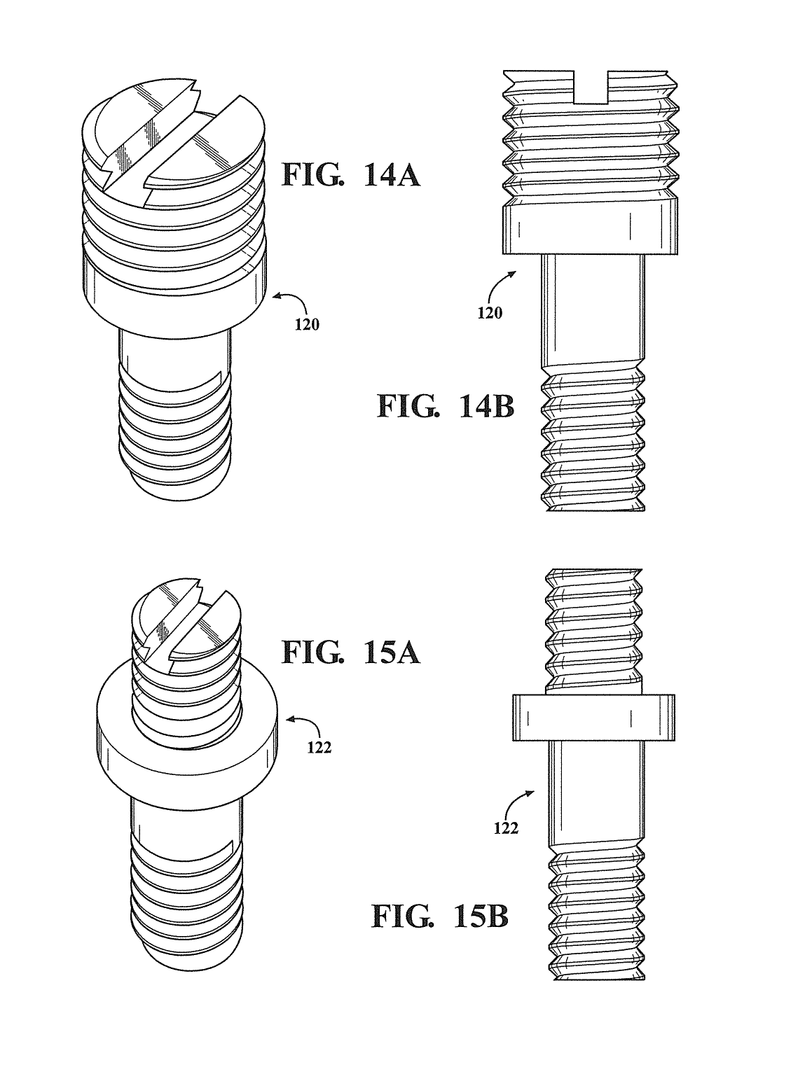

FIGS. 16A-16B are perspective and side views of a further combination hinge screw and mounting post, generally at 124, according to a further possible variant and exhibiting a flat head 126 and intermediate located and annular enlarged collar 56. The combination also includes a top screwdriver tip receiving slot 130, as well as external threads applied at 132 over the upper portion and further at 134 over the lower portion on opposite sides of the annular collar 128.

As previously described, the external threads can include a separation distance over which the collar 128 seats or, alternatively, the collar 128 can include internal threads (not shown) which adjustably engage with a single set of exterior threads which span the entire distance of the combination hinge screw and post. As further shown, the upper 132 and lower 134 sets of threads can exhibit any pitch or dimension and, as compared to those previously depicted in FIGS. 3-15, can also be of a finer (smaller) count as desired and depending upon the requirements of the associated eyewear.

FIGS. 17A-17B are perspective and side views, generally at 136, of a further variant of hinge screw and mounting post again exhibiting a flat head 138 with bit engaging recess 140, an annular enlarged collar 142 and, at a lower extending location, a conically tapered hinge through seating portion 144 suitable for inserting through the conventional eyeglass hinge (see again at 8-9 in FIG. 2C). External threaded locations are shown at 146 and 148, similar to as shown in FIGS. 16A-16B, with the difference being that a larger intermediate separation distance is provided between the upper and lower sets of threads.

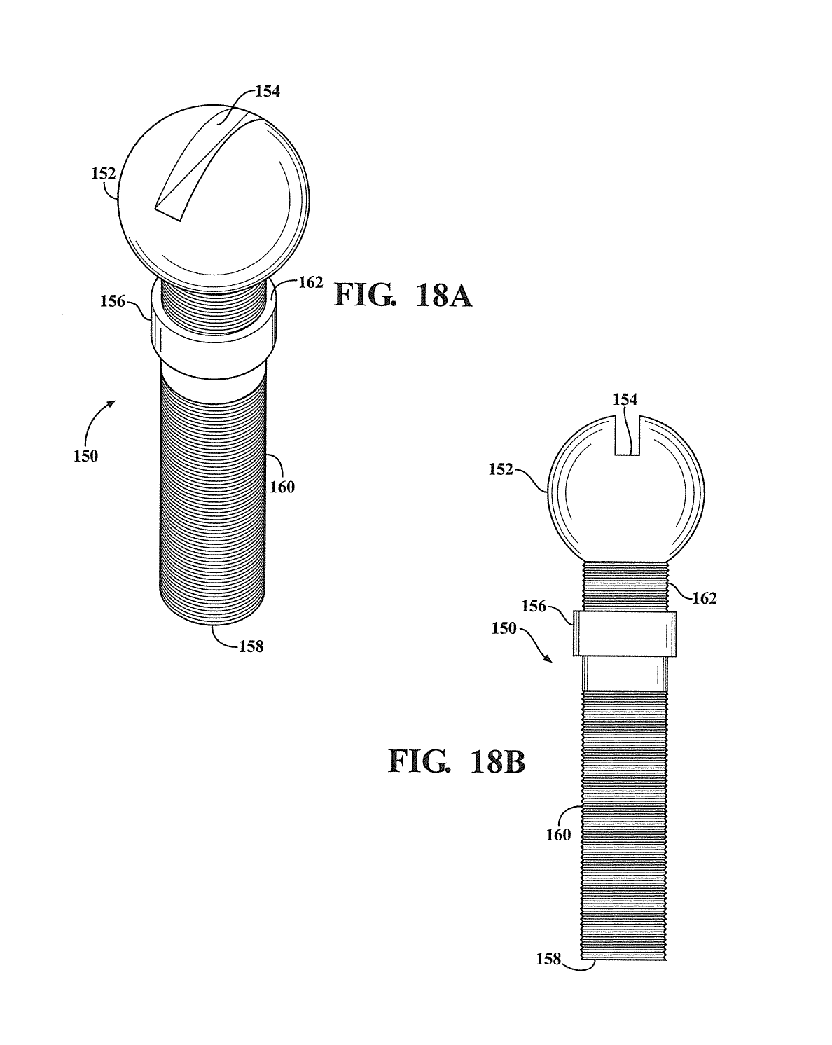

FIGS. 18A-18B are perspective and side views of a combination hinge screw and mounting post, generally at 150 according to a yet further variant and which employs a spherical head 152 to facilitate press-fit engagement of a decorative attachment (not shown). Additional features include upper screwdriver tip receiving slot 154 and intermediately position annular collar 156. The combination includes a flat bottom 158 and a main set of external threads 160 extending upwardly to a location a determined spaced distance below the intermediate collar 156. An optional and upper/secondary set of threads are further depicted at 162 between the underside of the spherical head 152 and the annular collar 156, the requirements for which is dependent in large part upon the configuration and design of the associated decorative head attachment (see again as previously shown at 38 in FIG. 3).

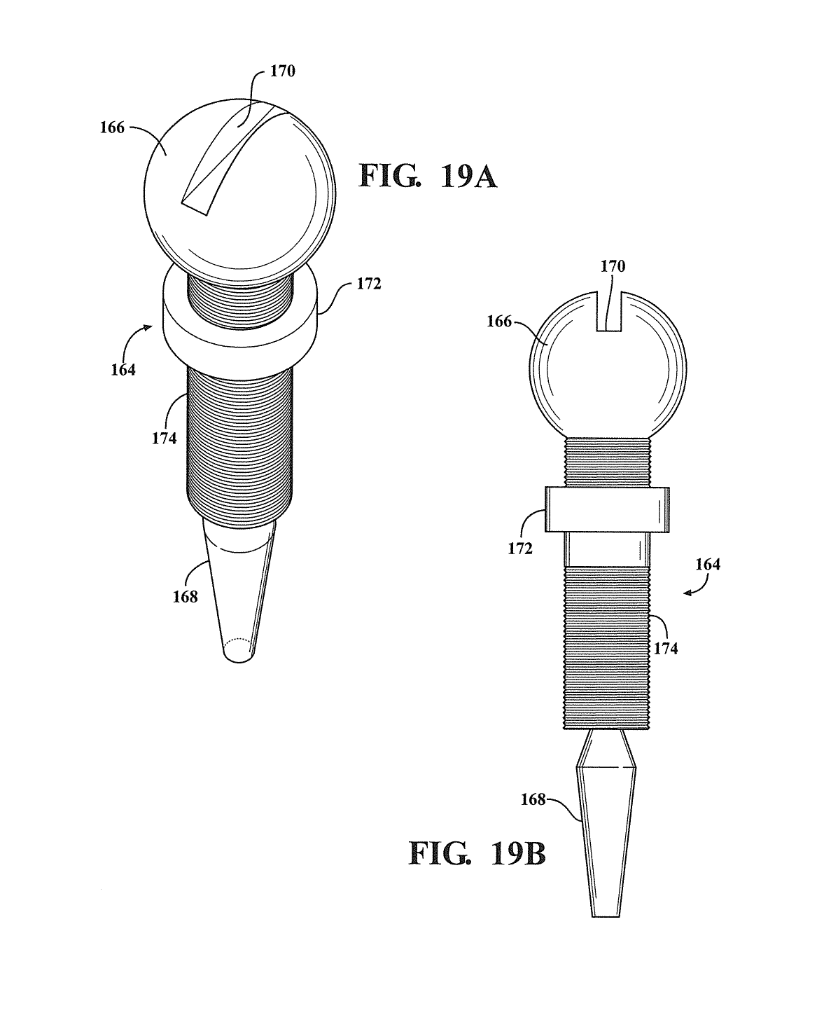

Finally, FIGS. 19A-19B are perspective and side views of a combination hinge screw and mounting post 164, this combining the characteristics off a spherical head 166 (see also FIG. 18) with a conically tapered hinge seating or engaging portion 168 (see also as shown at 144 in each of FIGS. 17A-17B). Other repetitive features include a top receiving screwdriver tip slot 170, an intermediately located annular collar 172 (again either fixed or adjustable) and a plurality of external threads 174 for facilitating engagement to the interior threads (not shown) associated with the eyeglass frame hinge locations.

The dimensional scale of all these combination screw and posts are consistent with the original screws being substituted, and further such that the upper integrally formed posts and intermediately located collars define an upwardly projecting portion of the combination once the lower screw portion is engaged within the eyeglass hinge. Accordingly, the present invention discloses a two part system typically including the hinge and post (itself either one piece or two inter-attachable pieces depending upon variant disclosed) and along with any plurality of separately attachable decorative elements.

This provides the additional advantage of allowing the user an enhanced degree of customization, this both additional to and beyond a simplified attachment option of FIGS. 1-2, and which defines a most basic variant of the invention. Additional related variants and aspects include the user being able to select a given combination hinge and post, along with any of a number of different collars or spacers which can be substituted, and again in combination with any style or configuration of top attachable decorative charms and pendants, and the like.

Beyond that disclosed, it is also envisioned that the charms and other decorative attachments can be secured in additional ways beyond press fitting upon the upper projecting ends of the posts. This can include any of a tab and slot, press and twist or threadable engagement established between the underside defined interior recess of the three dimensional decorative element and the opposing profile of the upwardly projecting post.

Having described my invention, other and additional preferred embodiments will become apparent to those skilled in the art to which it pertains, and without deviating from the scope of the appended claims.

1. A system for incorporating a decorative attachment into a hinge established within an eyeglass frame, comprising:
a first component including a first downwardly extending portion inserting within the hinge defined by aligning locations established between front and side portions of the eyeglass frame, said first component further having an upper projecting post; and
a second three dimensional component including any decorative configuration, said second component further exhibiting a recessed underside which facilitate installation of said second component upon said post.

2. The system as described in claim 1, further comprising a spacer at an intermediate location of said first component.

3. The system as described in claim 2, said spacer being linearly adjustable along said first component.

4. The system as described in claim 1, said first component further comprising a lower screw portion and an upper separable post portion.

5. The system as described in claim 4, further comprising a third end cap component which is attachable over said lower screw portion upon removal of said upper post.

6. The system as described in claim 5, each of said upper post portion and said end cap further comprising an underside recess with internal threads for engaging additional external threads applied over an upper and larger diameter portion of said screw portion.

7. The system as described in claim 1, said upper projecting post of said first component further comprising a flattened head.

8. The system as described in claim 1, said upper projecting post of said first component further comprising a spherical shaped head.

9. The system as described in claim 1, said upper projecting post of said first component further exhibit any of a flat, Phillips, hex or screw recess shaped pattern for receiving a screwdriver inserting bit portion.

10. The system as described in claim 1, said downwardly extending portion of said first component further comprising a conically tapered end.

11. A system for incorporating a decorative attachment into a hinge established within an eyeglass frame, comprising at least one component including a first downwardly extending portion inserting within the hinge defined by aligning locations established between front and side portions of the eyeglass frame and an upper projecting portion for seating thereupon any three dimensional element exhibiting a decorative configuration and which is adapted to extend above an upper adjoining edge established between a front and at least one side of the eyeglass frame.
